(19) United States
(12) Patent Application Publication
(10) Pub. No.: US 2010/0289800 A1
(43) Pub. Date: Nov. 18, 2010

(54) METHOD AND SYSTEM TO FACILITATE TRANSFORMATION PROCESS IMPROVEMENTS

(75) Inventor: MICHAEL D. MILLER, WINTERSET, IA (US)

Correspondence Address: ALSTON & BIRD LLP;PIONEER HI-BRED INTERNATIONAL, INC., BANK OF AMERICA PLAZA, 101 SOUTH TRYON STREET, SUITE 4000, CHARLOTTE, NC, 28280-4000, US

(73) Assignee: PIONEER HI-BRED INTERNATIONAL, INC., Johnston, IA (US)

(21) Appl. No.: 12/466,255

(22) Filed: May 14, 2009

(51) Int. Cl. G06T 11/20; G06T 1/00; G06F 3/048

(52) U.S. Cl. 345/440; 345/418; 715/771; 715/205

(57) ABSTRACT

A method for providing access to process-based documentation associated with producing transgenic plants is provided. Such a method may include displaying to a user an interactive process map to access data associated with a plurality of plant transformation processes, receiving from the user a selection within the interactive process map to select at least one of the plurality of plant transformation processes, and displaying to the user documentation describing the at least one of the plurality of plant transformation processes. The documentation may include laboratory experiment designs and laboratory experimental data associated with the plant transformation processes.

### FIELD OF THE INVENTION

The present invention relates to information management associated with one or more laboratories, and more particularly, the present invention relates to information management of processes associated with the production of transgenic plant products.

### BACKGROUND

There has not been a centralized system for tracking current or historical process improvement knowledge within various transformation labs and locations. Historically, this type of information was communicated in the form of oral presentations, various reports stored in disparate locations, word of mouth and telephone conversations with colleagues at other locations. This lack of a centralized process improvement knowledge base leads to inefficiencies in efforts to improve processes, both within and between labs.

Some examples of such inefficiencies may include repeating past experiments, duplication of current efforts, ineffective coordination within and between labs and locations, negative data not being communicated, and poor integration of new employees into the accumulated knowledge base.

What is needed is a way to manage information associated with a laboratory or a group of laboratories, especially information which facilitates transformation process improvements.

### SUMMARY

According to one aspect, a method for providing access to process-based documentation associated with producing transgenic plants is provided. Such a method may include displaying to a user an interactive process map to access information associated with a plurality of plant transformation processes, receiving from the user a selection within the interactive process map to select at least one of the plurality of plant transformation processes, and displaying to the user documentation describing at least one of the plurality of plant transformation processes. The documentation may include laboratory experiment designs and laboratory experimental data associated with the plant transformation processes.

According to another aspect, a computer-assisted method for information management associated with transformation of plants may include providing a user interface having graphical representations of processes associated with transformation of plants, the user interface having links to experimental designs underlying the processes and/or experimental data underlying the processes. The method further includes maintaining the experimental designs underlying the processes and/or the experimental data underlying the processes in computer accessible storage.

According to another aspect, a computer readable medium fur use in managing process improvements associated with transformation processes is provided. The computer readable medium includes instructions for displaying to a user an interactive process map to access data associated with the plant transformation processes. The invention further provides for receiving from the user a selection within the interactive process map to select at least one of the plurality of plant transformation processes. The instructions further provide for displaying documentation describing the plant transformation processes.

### BRIEF DESCRIPTION OF THE DRAWINGS

FIG. 1 is a screen display illustrating an example of a user interface with an interactive process map for use in documentation of the processes associated with production transformation.

FIG. 2 is a screen display further illustrating the user interface within an interactive process map for use in documentation of the processes associated with production transformation.

FIG. 3 is a screen display further illustrating the user interface within an interactive process map for use in documentation of the processes associated with production transformation.

FIG. 4 illustrates a screen display associated with plant transformation ideas.

FIG. 5 illustrates one manner of storing and organizing information regarding different experiments.

FIG. 6 is a block diagram illustrating an example of a network of laboratory computing devices with centralized database.

### DETAILED DESCRIPTION

A computerized framework has been created to facilitate the organization, communication and coordination of process improvement projects related to improving the efficiency and effectiveness of producing transgenic plants for product development.

The system includes a centralized, easily searchable database and a user friendly graphical interface which enables intuitive navigation to particular process improvement areas of interest. Once users navigate to any particular area of interest, the system provides users with searchable and accessible process improvement knowledge, both historic and current. The system allows individuals to enter their projects into a central, organized repository using a standardized, yet flexible format. Use of a standardized format enables the organization of data into a searchable knowledge base of both current and historic process improvement projects. The system may be built using any standard commercially or publicly available hardware, and/or software tools and applications such as Microsoft Access and IGrafx. The graphical user interface may appear as a dashboard or interactive process map. Selecting buttons with active links, for example as indicated by underlined text, allows a user to navigate to an area of interest. Searching within an area of interest is based on criteria such as project type, project owner(s), date started, date completed, process components, further actions, data or report(s) available, and/or process wastes that are being addressed. Once process improvement projects are entered into the database using the graphical user interface, the user can easily search the database for improvement knowledge.

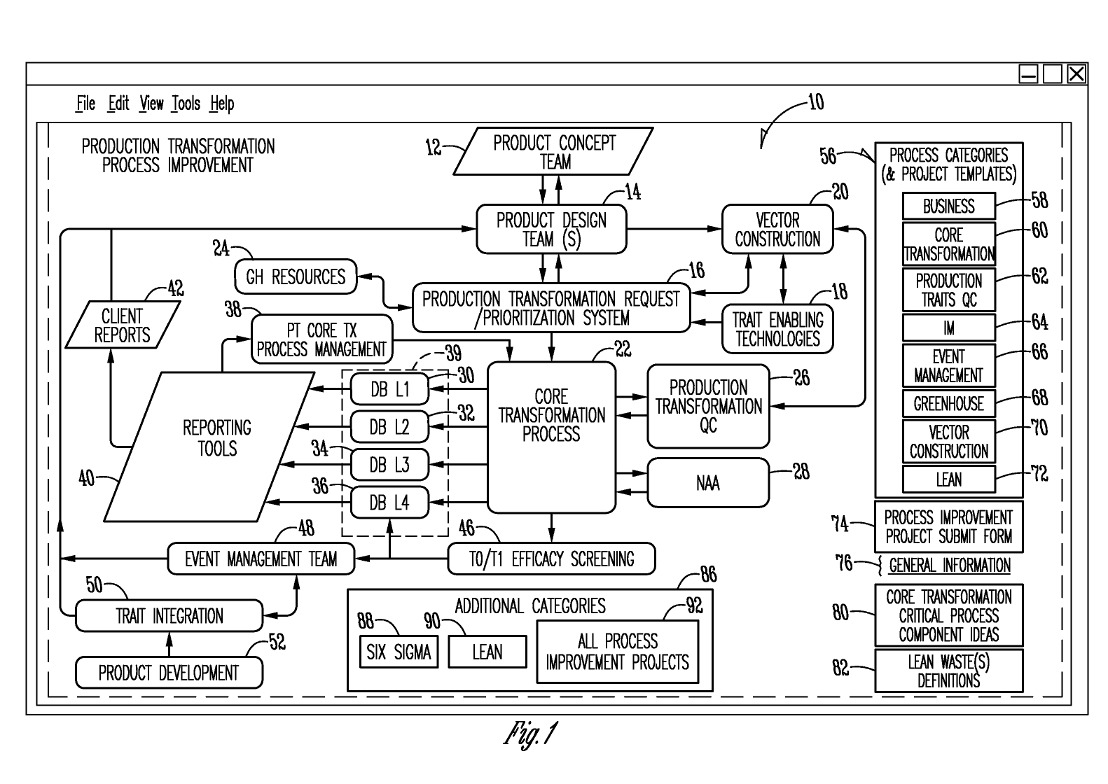

FIG. 1 illustrates one example of a high level process improvement map 10. The map 10 is provided for production transformation process improvement. The map 10 illustrates the relationships and interactions between different aspects associated with transformation process improvement. Of course, higher level process improvement maps may be used, for example, corn transformation may include not only production transformation projects, but further include gene testing, promoter testing, or any other data or processes relevant to the project. Within an organization, higher level process improvement maps may also be used to select between products such as corn, soybeans, rice, or other products. Thus, for example a researcher in the corn transformation area may also access process improvement knowledge from other crops. Sometimes these other crops have analogous process components which if the researcher in the corn transformation area could view, might affect their decision as to how to best design experiments for corn transformation.

The process map 10 is used to illustrate interaction between different processes associated with production transformation. Note that the processes involved need not include experimental data, as the processes may be business processes, information management processes, or other processes associated with production transformation. A product concept team 12 is shown which interacts with a product design team 14. The product design team 14 interacts with a production transformation request/prioritization system 16. Requests may come in for both research and product development purposes. For example, a request associated with trait enabling technology may be one example of a research request. Requests may also be related to other areas. For example greenhouse (GH) resources 24 may be related to the production transformation request 16. Vector constructions 20 may be related to the trait enabling technologies 18, the production transformation request/prioritization system 16, and the production transformation quality control 26. The process map can also link to other analysis, data, and/or analysis request options, for example nucleic acid analysis requests and/or data (NAA) 28 is also shown which is related to the core transformation processes. A database layer one 30, layer two 32, layer three 34, and layer four 36 are shown. Although four database layers 30, 32, 34, 36 are shown, it is to be understood that the use of layers or tables is merely one way to assist in organization of data within the database 39. The database 39 may include any number of tables or layers. The database 39 is in communication with the core transformation process 22 as well as the reporting tools 40. Client reports 42 may be generated from the reporting tools 40. Custom reports may be easily created. Reports may be automatically updated on a periodic basis and/or delivered via email to interested parties.

Production transformation core transformation process management 38 is also shown as connected to the reporting tools 40 and the core transformation process 22. T0/T1 efficacy screening 46 is also related to the database, such as the fourth layer 36. The T0/T1 efficacy screening 46 is related to the event management team 48 which is in communication with the product design team 14. The event management team 48 is also related to trait integration 50. Trait integration 50 is also related to product development 52.

Other categories related to product improvement are also provided. These include six sigma projects 88, lean projects 90, or all process improvement projects 92. Thus, many different types of process improvement projects may be organized.

The map 10 may be colored coded, such as by process category. For example business processes 58 may be assigned a first color. Core transformation processes 60 may be assigned a second color, production trait quality control processes 62 may be assigned a third color, information management processes 64 may be assigned a fourth color. Event management processes 66 may be assigned a fifth color. Greenhouse processes 68 may be assigned a sixth color, and so on.

The map 10 provides an overview of production transformation processes and provides insight into relationships between different resources and groups associated with production transformation. The process map 10 has numerous uses. For example, the process map 10 may be especially useful to new employees who need to learn the relationships between different resources and groups associated with production transformation. At any time a user can select different processes to learn more information about various processes and/or various projects, including information at the level of experimental data. The information accessible through the process map 10 is also searchable so that a user may perform a search for specific information. One's ability to find such information is advantageous as it allows a user to avoid performing experiments that have already been performed, to design experiments more likely to be successful based on past experiments (including unsuccessful experiments), and/or integrate their experiment, idea(s), and/or results into the larger context of the database.

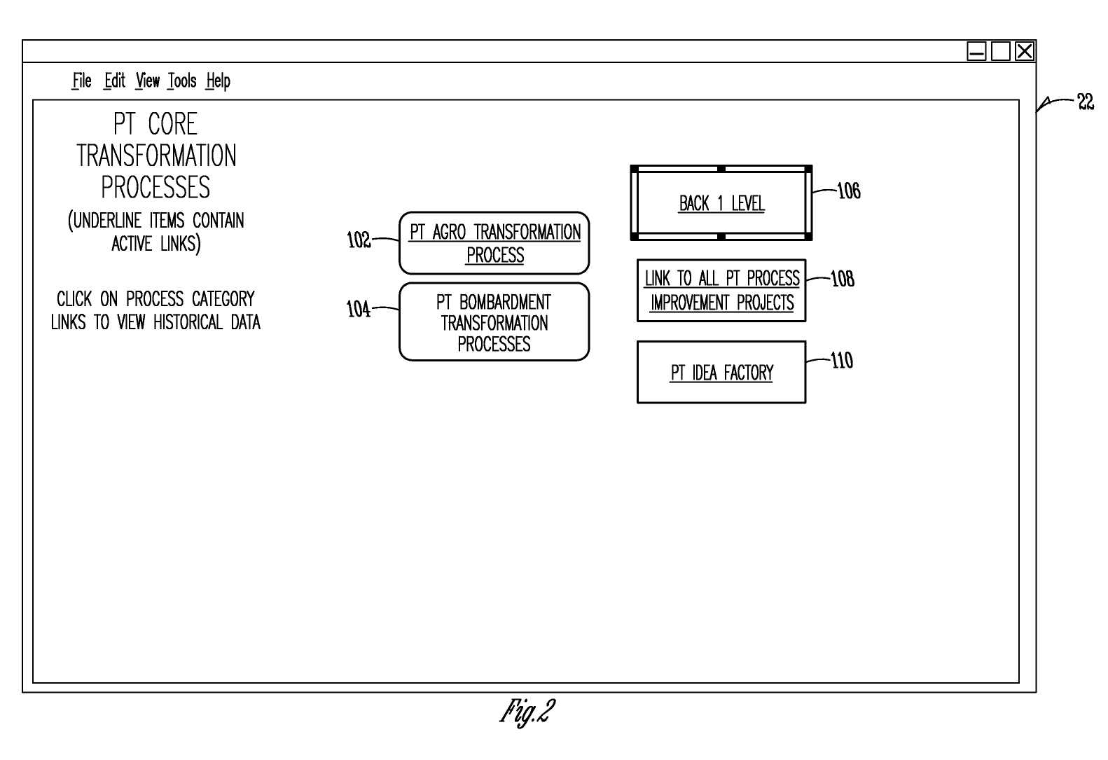

Once a user selects the core transformation process 22, the display of FIG. 2 is shown. The core transformation process 22 provides links to plant transformation processes, such as Agrobacterium-mediated plant transformation processes 102, or particle bombardment plant transformation processes 104. In addition, a link 106 back to FIG. 1 is provided. Also there is a link 108 to show all plant transformation process improvement projects. There is also a link 110 to a place to input, track, and/or compile plant transformation or process improvement ideas.

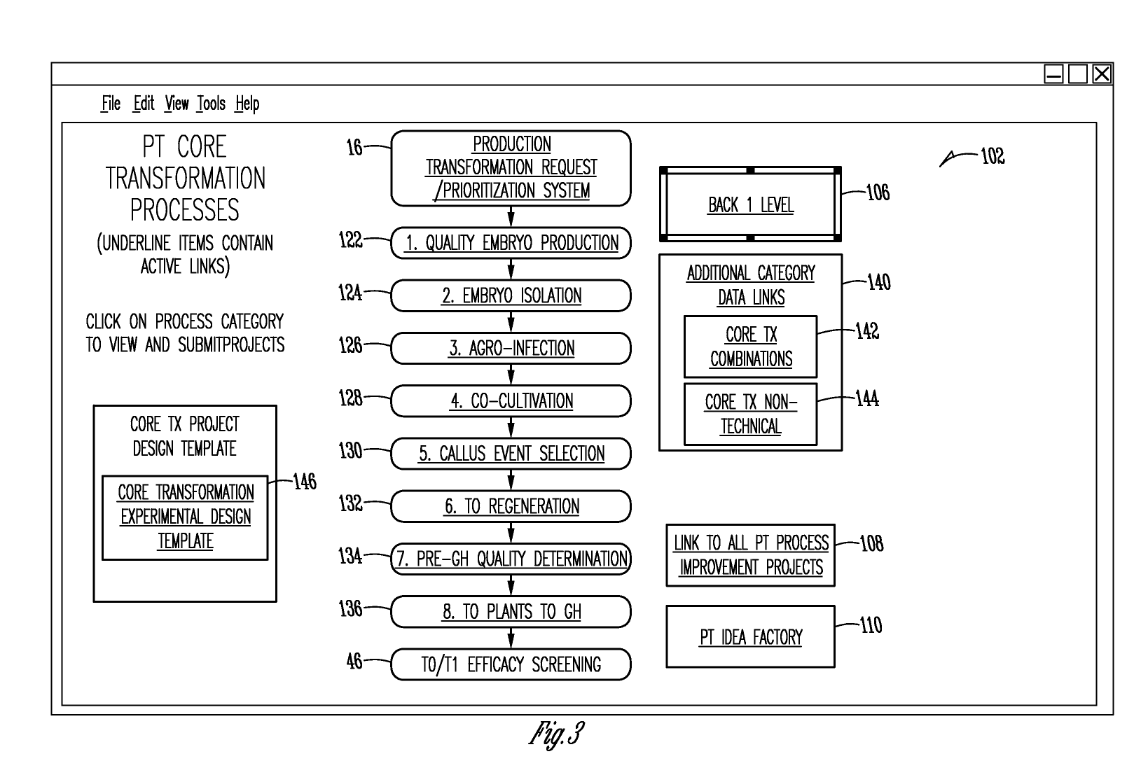

Once a user selects the plant transformation agro transformation process 102 in FIG. 2, a plant transformation dashboard is shown in FIG. 3. As shown in FIG. 3, a process for plant transformation using Agrobacterium is shown. A production transformation request is received from the production transformation request/prioritization system 16. In a first step, quality embryo production 122 is performed. In a second step, embryo isolation 124 is performed. In a third step, agro-infection 126 is performed. In a fourth step, co-cultivation 128 is performed. In a fifth step, callus event selection 130 is performed. In a sixth step, T0 plant regeneration 132 is performed. In a seventh step, a pre-greenhouse quality determination 134 is made. In an eighth step, the T0 plants are transferred to the greenhouse 136. Each of these steps has an associated link for providing additional information regarding process improvement activities related to each to these steps. Optionally, T0/T1 efficacy screening 46 is later performed.

The screen display of FIG. 3 also includes a link for a core transformation project experimental design template 146. Thus, if a user wants to seek to improve the plant transformation process, they may design new experiments, documenting the experiments with the core transformation experimental design template. Use of an experiment design template assures information regarding a project is organized in a meaningful consistent format understandable to all researchers utilizing this system. Additional category data links are also provided. For example, there is a core transformation combinations link 142 and a core transformation non-technical link 144. There is also a link to all process improvement projects 108, and a link to plant transformation ideas 110.

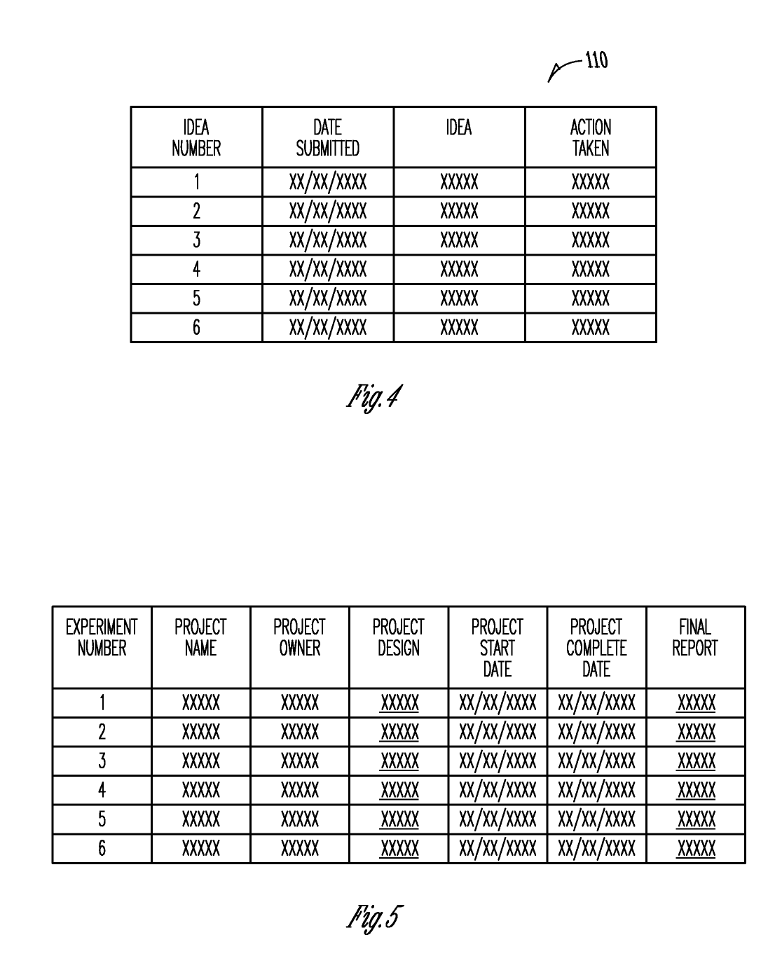

FIG. 4 illustrates a screen display associated with plant transformation ideas 110. The plant transformation ideas may be listed in a spreadsheet, database, or other application. Information which may be used may include idea number (or other identifier), the date the idea was submitted, a description of the idea (IDEA), and the action taken regarding the idea. Optionally, any one or more of these fields can contain links to other database objects and/or files.

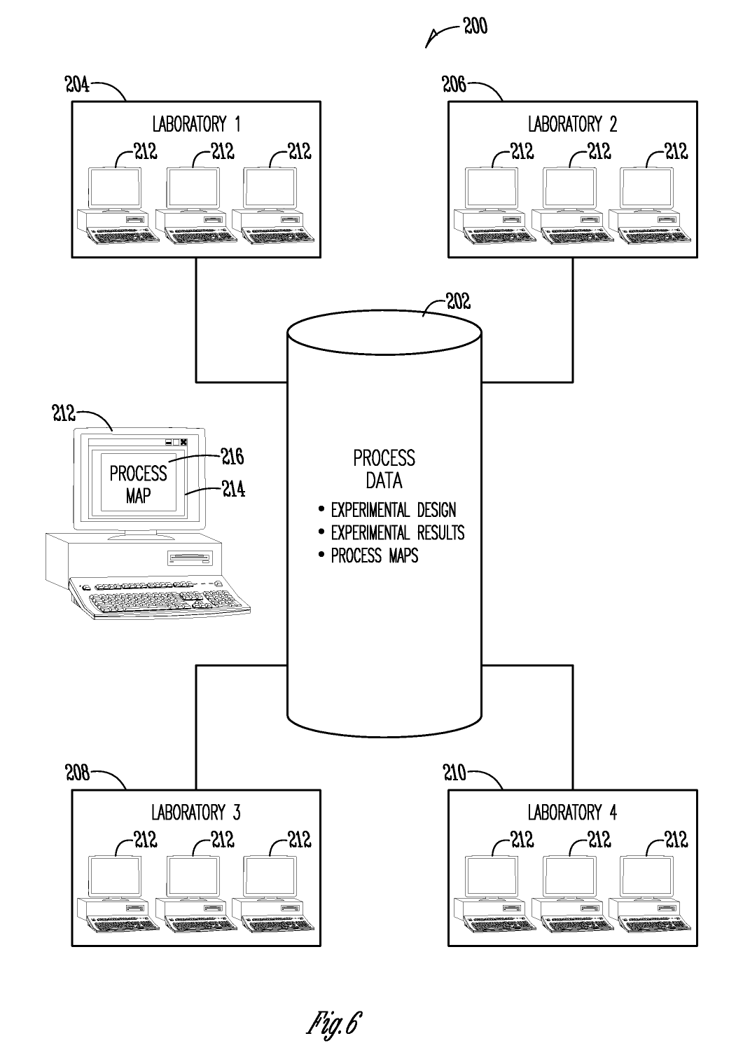

FIG. 5 illustrates one manner of storing and organizing information regarding different experiments. Data regarding experiments may be listed in a spreadsheet, database, or other application. Information which may be shown may include experiment number, project name, project owner, project design, project start date, project completion data, and a final report. The project design and the final report may be links to other database objects and/or documents which provide the project design, and/or any final report(s).

FIG. 6 provides a block diagram illustrating one example of a computer network 200 in which the system may be used. As shown in FIG. 6, there is a first laboratory 204 with a number of computers 212 associated with the laboratory. There is a second laboratory 206 with a number of computers 212 associated with the laboratory. There is a third laboratory 208 with a number of computers 212 associated with that laboratory. There is also a fourth laboratory 210 with a number of computers 212 associated with that laboratory. Each of the computers 212 associated with each of the laboratories is in operative communication with a process database or data store 202. The process database may include such information as experimental designs, experimental results, and/or process maps. An application 214 may be stored on a computer readable medium to allow each of the computers 212 to access the database through a process map 216. The application may be stored on one or more of the computers 212 or may be stored on a central server associated with the process database 202.

Thus, scientists from different laboratories have access to the same data regardless of whether the data was generated in their own laboratory, a laboratory down the hall, or a laboratory across the world. Moreover, scientists have access to data regarding process improvements efforts regardless of whether the experiment was conducted last week or years ago.

In this way, information regarding different experiments may be organized and reorganized in various ways and in a convenient to access manner. The information collected may include information from unsuccessful experiments as well as successful experiments. Numerous advantages may be achieved. One such advantage is the establishment of a long-term searchable archive of accumulated process improvement knowledge. The described software tool and process mapping process provides effective coordination of process improvement efforts between laboratories even when those laboratories are at locations remote from one another. In addition, individuals new to a laboratory may be quickly educated regarding what experiments have already been attempted. Also, one can see which individual or individuals were involved in a particular experiment so that an appropriate individual may be contacted to discuss a particular experiment or idea. In addition, all process improvements related to product transformation may be tracked, where process improvements include but are not limited to processes that improve throughput time, processes that overcome a bottleneck, processes that improve or facilitate compliance with safety, good lab practices, ISO9000, EPA or any other regulatory or certification standards, rules, or processes, processes that improve the quality of the data or end product, aggregating and/or relating relevant processes, experiments, or data, or any other improvement, improving recording, reporting, tracking and/or access to data and experimental results, and any other improvements. Thus, multiple levels of knowledge including scientific or technical knowledge, experimental knowledge, process knowledge, business knowledge, and other process improvement knowledge may be organized and brought together in an organized, intuitive, and searchable format.

While the foregoing is illustrative, the present invention is not to be limited to the specific embodiments, examples, or description provided herein. It will be appreciated that various changes and modifications may be made without departing from the spirit and scope of the invention.

What is claimed is:

1. A method for providing access to process-based documentation associated with producing transgenic plants, the method comprising:
displaying to a user an interactive process map comprising information associated with a plurality of plant transformation processes;
receiving from the user a selection within the interactive process map to select at least one of the plurality of plant transformation processes;
displaying to the user documentation describing the at least one of the plurality of plant transformation processes;
wherein the documentation includes laboratory experiment designs associated with the plant transformation processes.

2. The method of claim 1 wherein the documentation further includes laboratory experimental data associated with the laboratory experiment designs.

3. The method of claim 2 wherein the laboratory experiment designs and laboratory experimental data associated with experiments is from a plurality of laboratories.

4. The method of claim 1 wherein the plurality of plant transformation processes are associated with production of transgenic plants.

5. The method of claim 1 wherein the interactive process map is stored on a computer readable medium.

6. The method of claim 1 wherein the steps of displaying are performed using a computer application stored on a computer readable medium.

7. The method of claim 1 wherein the documentation further comprises process improvement projects.

8. The method of claim 1 wherein the process map is color-coded.

9. The method of claim 8 wherein the process map is color-coded by process categories, the process categories including at least one of business, core transformation, product trait quality control, information management, event management, greenhouse, and vector construction.

10. The method of claim 1 wherein the interactive process map includes at least one of a link to transformation processes, a link to experiment workflow information, and a link to a project design template.

11. A computer-assisted method for information management associated with transformation of plants, the computer-assisted method comprising:
providing a user interface comprising graphical representations of processes associated with transformation of plants, the user interface having links to experiment designs underlying the processes; and
maintaining the experiment designs underlying the processes and data in computer accessible storage.

12. The computer-assisted method of claim 11 wherein the user interface further having links to experimental data underlying the processes.

13. The computer-assisted method of claim 12 further comprising maintaining the experimental data underlying the processes in the computer accessible storage.

14. The computer-assisted method of claim 13 further comprising receiving from a user additional experimental designs and experimental data associated with one of the processes and storing the additional experimental designs and experimental data in the computer accessible storage.

15. The computer-assisted method of claim 11 wherein the user interface provides a link to process improvement projects.

16. The computer-assisted method of claim 11 wherein the user interface color-codes the processes by process category.

17. The computer-assisted method of claim 11 wherein instructions for providing the user interface are stored on a computer readable medium.

18. The computer-assisted method of claim 11 wherein the user interface includes at least one of a link to a transformation process, a link to experiment workflow information and a link to a project design template.

19. A computer readable medium for use in managing process improvements associated with transformation processes, the computer readable medium comprising instructions for:
displaying to a user an interactive process map to access data associated with a plurality of plant transformation processes;
receiving from the user a selection within the interactive process map to select at least one of the plurality of plant transformation processes; and,
displaying to the user documentation describing the at least one of the plurality of plant transformation processes;
wherein the documentation includes laboratory experiment designs and laboratory experimental data associated with the plant transformation processes.

20. The computer readable medium of claim 19 wherein the laboratory experiment designs and laboratory experimental data associated with experiments are from a plurality of laboratories.

21. The computer readable medium of claim 19 wherein the plurality of plant transformation processes are associated with production plant transformation processes.

22. The computer readable medium of claim 19 wherein the documentation further comprises process improvement projects.

23. The computer readable medium of claim 19 wherein the process map is color-coded.

24. The computer readable medium of claim 19 wherein the process map is color-coded by process categories, the process categories including business, core transformation, product trait quality control, information management, event management, greenhouse, and vector construction.

25. The computer readable medium of claim 19 wherein the interactive process map includes at least one of a link to a transformation process, a link to experiment workflow information, and a link to a project design template.
